(19) United States
(12) Patent Application Publication
(10) Pub. No.: US 2026/0160896 A1
(43) Pub. Date: Jun. 11, 2026

(54) METHOD OF PERFORMING INDOOR POSITIONING IN GNSS SYSTEM AND APPARATUS FOR SUPPORTING THE METHOD

(71) Applicant: ELECTRONICS AND TELECOMMUNICATIONS RESEARCH INSTITUTE, Daejeon (KR)

(72) Inventors: SEONGHUN SEO, Daejeon (KR); Yonghyun Kim, Daejeon (KR)

(21) Appl. No.: 19/402,269

(22) Filed: Nov. 26, 2025

(30) Foreign Application Priority Data
Dec. 5, 2024 (KR) 10-2024-0179731

(51) Int. Cl. G01S 19/11; G01S 19/40

(52) U.S. Cl. CPC G01S 19/11; G01S 19/40

(57) ABSTRACT

A composite signal transmission apparatus for performing indoor positioning in a global navigation satellite system (GNSS) system is provided. The composite signal transmission apparatus includes a controller configured to receive a satellite signal through an antenna from a GNSS satellite and analyze an orbit of the GNSS satellite and a status of the satellite signal, based on the received satellite signal, a GNSS transmitter configured to generate a pseudo-GNSS signal by using the received satellite signal and transmit the generated pseudo-GNSS signal, and an ultra-wideband (UWB) transmitter configured to generate a UWB signal and transmit the generated UWB signal.

### CROSS-REFERENCE TO RELATED APPLICATION(S)

This application claims the benefit of the Korean Patent Application No. 10-2024-0179731 filed on Dec. 5, 2024, which is hereby incorporated by reference as if fully set forth herein.

### BACKGROUND

### 1. Field of the Invention

The present disclosure relates to a method of performing indoor positioning, and more particularly, to a method of increasing a position estimation performance of a navigation solution calculated in a low-price terminal by using a global navigation satellite system (GNSS) signal and an ultra-wideband (UWB) signal in a GNSS system and an apparatus for supporting the method.

### 2. Description of Related Art

In conventional positioning technologies, a boundary capable of being used in an indoor or outdoor zone is clearly distinguished generally. Absolute positioning based on a global navigation satellite system (GNSS) signal is being mainly used in an outdoor zone, and a positioning accuracy of a cm level is provided in an open zone. In an indoor zone, because the use of a real satellite signal is very restrictive, other position technology for complementing the restriction is used. In this case, when a pseudo-GNSS signal is used, positioning may be performed by intactly using a GNSS receiver used in an outdoor zone. Because such a method is a method of installing equipment to artificially provide a GNSS signal, there is a limitation in accuracy and cost, based on a method of constructing a pseudo-GNSS system. Also, an ultra-wideband (UWB) signal may be used in indoor positioning. The UWB signal provides a range measurement value having a very high accuracy of a cm level in a radius of about 100 m. However, a signal processing method and separate equipment such as a UWB receiver for receiving a separate UWB signal are needed for using the UWB signal. A UWB receiver is fundamentally equipped in smartphones released recently, and thus, in a case which uses a smartphone, a UWB signal may be used without installing a separate UWB receiver.

However, in order to use a UWB signal as an additional range measurement value, other hardware (HW) should be separately installed at a position differing from a GNSS pseudo satellite apparatus which provides a pseudo range. Also, accurate visual synchronization between physically divided apparatuses is needed. That is, when a pseudo-GNSS signal and a UWB signal are capable of being transmitted in visual synchronization with each other in one transmission module, the internal signal acquisition and tracking performance of a GNSS receiver may be enhanced, and thus, the enhancement of positioning accuracy may be possible.

### SUMMARY

Therefore, the present disclosure provides a composite signal transmission/reception processing system which may simultaneously transmit and receive a pseudo-GNSS signal and a UWB signal and may thus enhance an accuracy of positioning with maintaining satellite information by using an GNSS receiver in an indoor zone.

The object of the present invention is not limited to the aforesaid, but other objects not described herein will be clearly understood by those skilled in the art from descriptions below.

To achieve these and other advantages and in accordance with the purpose of the invention, as embodied and broadly described herein, there is provided a composite signal transmission apparatus for performing indoor positioning in a global navigation satellite system (GNSS) system, the composite signal transmission apparatus including: a controller configured to receive a satellite signal through an antenna from a GNSS satellite and analyze an orbit of the GNSS satellite and a status of the satellite signal, based on the received satellite signal; a GNSS transmitter configured to generate a pseudo-GNSS signal by using the received satellite signal and transmit the generated pseudo-GNSS signal; and an ultra-wideband (UWB) transmitter configured to generate a UWB signal and transmit the generated UWB signal.

Moreover, in the present disclosure, the controller may analyze the orbit of the GNSS satellite and the status of the satellite signal to generate information associated with generating of the pseudo-GNSS signal and the UWB signal and may provide the information to each of the GNSS transmitter and the UWB transmitter.

Moreover, in the present disclosure, the controller may be functionally connected to the GNSS transmitter and the UWB transmitter, and the GNSS signal and the UWB signal may be temporally synchronized with each other.

Moreover, in the present disclosure, the GNSS transmitter and the UWB transmitter may be implemented as one module.

In another aspect of the present invention, there is provided a composite signal reception apparatus for performing indoor positioning in a global navigation satellite system (GNSS) system, the composite signal reception apparatus including: a GNSS receiver configured to receive, through an antenna, a pseudo-GNSS signal transmitted from a composite signal transmission apparatus and calculate a GNSS satellite-based GNSS pseudo range through signal acquisition and a tracking loop for each channel; an ultra-wideband (UWB) receiver configured to receive, through the antenna, a UWB signal transmitted from the composite signal transmission apparatus and calculate a range between the composite signal transmission apparatus and the composite signal reception apparatus through transmission/reception switching and two-way ranging for each channel; and a controller functionally connected to the GNSS receiver and the UWB receiver, wherein the controller controls the UWB receiver to provide the tracking loop of the GNSS receiver with range information about the range calculated by the UWB receiver.

Moreover, in the present disclosure, the GNSS receiver may generate correction information for tracking the pseudo-GNSS signal, based on the range information.

Moreover, in the present disclosure, the composite signal reception apparatus may further include a navigation filter configured to calculate a position of the composite signal reception apparatus.

Moreover, in the present disclosure, the GNSS receiver may calculate the GNSS satellite-based GNSS pseudo range by using the correction information.

Moreover, in the present disclosure, the navigation filter may calculate a position of the composite signal reception apparatus, based on the calculated GNSS pseudo range.

In another aspect of the present invention, there is provided a global navigation satellite system (GNSS) system for performing indoor positioning by using a GNSS signal and an ultra-wideband (UWB) signal, the GNSS system including: a composite signal transmission apparatus configured to analyze an orbit of a GNSS satellite and a status of a satellite signal received from the GNSS satellite, based on the received satellite signal, generate and transmit a pseudo-GNSS signal by using the received satellite signal, and generate and transmit a UWB signal; and a composite signal reception apparatus configured to receive a pseudo-GNSS signal transmitted from the composite signal transmission apparatus to calculate a GNSS satellite-based GNSS pseudo range through signal acquisition and a tracking loop for each channel and receive a UWB signal transmitted from the composite signal transmission apparatus to calculate a range to the composite signal transmission apparatus through transmission/reception switching and two-way ranging for each channel.

Moreover, in the present disclosure, the composite signal transmission apparatus may analyze the orbit of the GNSS satellite and the status of the satellite signal to generate information associated with generating of the pseudo-GNSS signal and the UWB signal.

Moreover, in the present disclosure, the GNSS signal and the UWB signal may be temporally synchronized with each other.

Moreover, in the present disclosure, the composite signal reception apparatus may provide the tracking loop with range information about the calculated range to the composite signal transmission apparatus.

Moreover, in the present disclosure, the composite signal reception apparatus may generate correction information for tracking the pseudo-GNSS signal, based on the range information.

Moreover, in the present disclosure, the composite signal reception apparatus may calculate the GNSS satellite-based GNSS pseudo range by using the correction information.

Moreover, in the present disclosure, the composite signal reception apparatus may calculate a position of the composite signal reception apparatus, based on the calculated GNSS pseudo range.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a diagram illustrating an example of an internal block diagram of a transmission apparatus and a reception apparatus of a GNSS system according to embodiments of the present disclosure;

FIG. 2 is a diagram illustrating an example of positioning accuracy based on a position of a user terminal and an indoor positioning environment using pseudo-GNSS;

FIG. 3 is a diagram illustrating an example of indoor positioning accuracy based on a position of a user terminal and an indoor positioning environment using a GNSS system simultaneously transmitting a pseudo-GNSS signal and a UWB signal, according to embodiments of the present disclosure;

FIG. 4 is a diagram illustrating another example of an internal block diagram of a composite signal transmission apparatus according to embodiments of the present disclosure;

FIG. 5 is a diagram illustrating an example of an internal block diagram of a composite signal reception apparatus according to embodiments of the present disclosure;

FIG. 6 is a diagram illustrating another example of an internal block diagram of a composite signal reception apparatus according to embodiments of the present disclosure;

FIGS. 7A and 7B are diagrams illustrating an example of a real signal acquisition result based on a combination of two pseudo-GNSS signals and a multi tracking result of two pseudo-GNSS signals obtained through a composite signal reception apparatus according to embodiments of the present disclosure;

FIG. 8 is a diagram illustrating an example of a result of acquiring a real signal in a composite signal reception apparatus according to embodiments of the present disclosure;

FIG. 9 is a flowchart illustrating an example of a composite signal transmission method for performing indoor positioning in a GNSS system according to embodiments of the present disclosure; and

FIG. 10 is a flowchart illustrating an example of a composite signal reception method for performing indoor positioning in a GNSS system according to embodiments of the present disclosure.

### DETAILED DESCRIPTION OF THE INVENTION

The terminology used herein is for the purpose of describing particular embodiments only and is not intended to be limiting of the invention. Unless otherwise defined, all terms used herein have the same meaning as commonly understood by one of ordinary skill in the art to which this invention pertains, and should not be interpreted as having an excessively comprehensive meaning nor as having an excessively contracted meaning. If technical terms used herein is erroneous that fails to accurately express the technical idea of the present invention, it should be replaced with technical terms that allow the person in the art to properly understand. The general terms used herein should be interpreted according to the definitions in the dictionary or in the context and should not be interpreted as an excessively contracted meaning.

It will be understood that although the terms including an ordinary number such as first or second are used herein to describe various elements, these elements should not be limited by these terms. These terms are only used to distinguish one element from another element. For example, a first element may be referred to as a second element without departing from the spirit and scope of the present invention, and similarly, the second element may also be referred to as the first element.

Hereinafter, embodiments described in the present disclosure will be described in detail with reference to the accompanying drawings, like reference numerals refer to like or similar elements regardless of reference numerals, and their repeated descriptions are omitted.

Moreover, in describing technology described in the present disclosure, when it is determined that detailed descriptions of related technology known to those of ordinary skill in the art obscure the gist of technology described in the present disclosure, the detailed descriptions are omitted. Also, the accompanying drawings are merely for helping easily understand the inventive concept described in the present disclosure, and it should not be construed that the accompanying drawings limit the inventive concept.

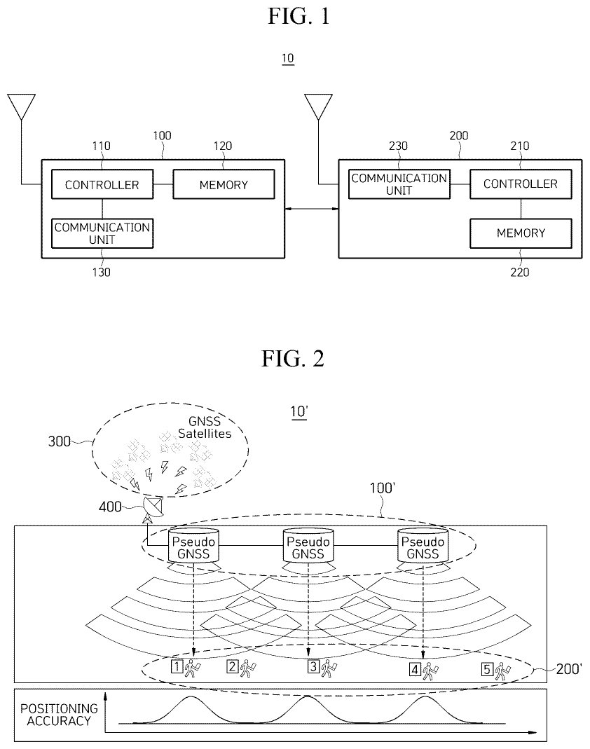

FIG. 1 is a diagram illustrating an example of an internal block diagram of a transmission apparatus and a reception apparatus of a GNSS system 10 according to embodiments of the present disclosure.

Referring to FIG. 1, the GNSS system 10 according to embodiments of the present disclosure may include a transmission apparatus 100 and a reception apparatus 200.

The transmission apparatus 100 may be an apparatus which receives a satellite signal from a GNSSS satellite and transmits a GNSS signal and a UWB signal to the reception apparatus 200, based on the satellite signal and may be referred to as a composite signal transmission apparatus or a transmitting end. The reception apparatus 200 may be an apparatus which receives the GNSS signal and the UWB signal transmitted from the transmission apparatus 100 to measure a position of a user and may be referred to as a composite signal reception apparatus, a receiving end, a user terminal, or user equipment.

Each of the transmission apparatus and the reception apparatus may be referred to as a wireless apparatus.

Each of the transmission apparatus and the reception apparatus may include a controller or a processor 110 and 210, a memory 120 and 220, and a communication unit 130 and 230.

The controller 110 and 120 may implement a function, a process, and/or a method according to embodiments of the present disclosure described below. The memory may be connected to the controller and may store various information for driving the controller. The communication unit may be connected to the controller and may transmit and/or receive a wireless signal.

Hereinafter, a method of performing precise positioning in an indoor zone by using a pseudo-GNSS signal and a UWB signal in the GNSS system according to embodiments of the present disclosure will be described in more detail with reference to the drawings.

‘Pseudo-GNSS’ and ‘GNSS’ used herein may be construed as the same meaning unless specially described, and for convenience, may be referred to as ‘pseudo-GNSS’.

FIG. 2 is a diagram illustrating an example of positioning accuracy based on a position of a user terminal and an indoor positioning environment using pseudo-GNSS.

Referring to FIG. 2, a GNSS system 10′ may include a GNSS satellite 300, a GNSS antenna 400, a pseudo-GNSS apparatus 100′, and a user terminal 200′.

The pseudo-GNSS apparatus 100′ may be referred to as a transmission apparatus or a transmitting end, and the user terminal may be referred to as user equipment, a receiving end, or a reception apparatus.

The pseudo-GNSS apparatus 100′ may generate a virtual satellite signal corresponding to a specific target position and may transmit or radiate the generated satellite signal to the user terminal. Therefore, a position of a user terminal at all reception points capable of receiving a satellite signal transmitted from the same pseudo-GNSS apparatus may be identically calculated or measured. That is, in a case where a satellite signal received at a plurality of reception points is transmitted from the same GNSS apparatus, a position at the plurality of reception points may be identically measured.

Therefore, in order to perform indoor positioning by using a characteristic of the pseudo-GNSS apparatus, the GNSS system should include a plurality of pseudo-GNSS apparatuses, and each of the pseudo-GNSS apparatuses may generate a pseudo-GNSS signal for different positions and may radiate the generated pseudo-GNSS signal to a user terminal. As described above, when the GNSS system includes a plurality of pseudo-GNSS apparatuses, a satellite signal transmitted from a pseudo-GNSS apparatus may be the most strongly received at positions of user terminals No. 1, No. 3, and No. 4 illustrated in FIG. 2, and thus, accurate positions may be calculated at the positions of the user terminals. Accordingly, an indoor positioning error may be small, but an indoor positioning error may largely occur at a position of a user terminal No. 2, which is received in a state where two or more pseudo-GNSS signals overlap each other, and a position of a user terminal No. 5 distancing from the pseudo-GNSS apparatus.

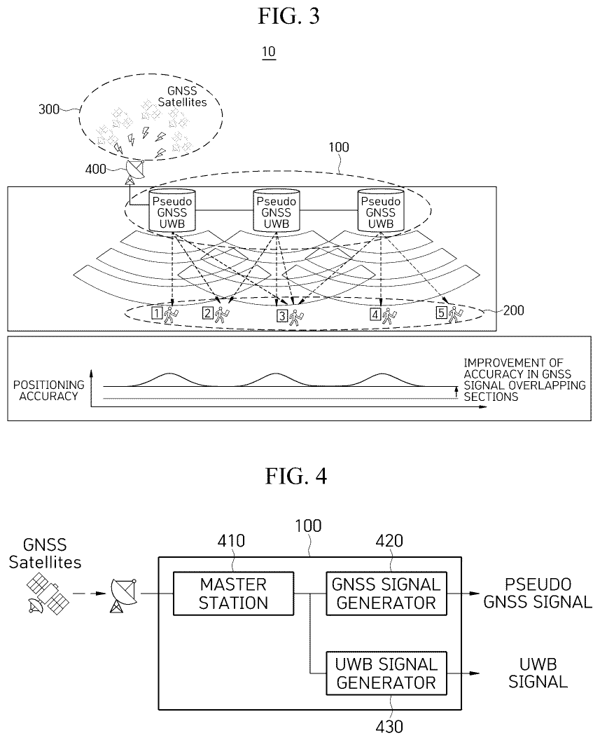

FIG. 3 is a diagram illustrating an example of indoor positioning accuracy based on a position of a user terminal and an indoor positioning environment using a GNSS system simultaneously transmitting a pseudo-GNSS signal and a UWB signal, according to embodiments of the present disclosure.

Referring to FIG. 3, a GNSS system 10 according to embodiments of the present disclosure may include a GNSS satellite 300, a GNSS antenna 400, a composite signal transmission apparatus 100, and a user terminal 200.

The composite signal transmission apparatus 100 may have a structure where a pseudo-GNSS apparatus (or a pseudo-GNSS module) and a UWB apparatus (or a UWB module) are combined and may be implemented as one integrated apparatus or module where a UWB apparatus is added to the pseudo-GNSS apparatus 300 of FIG. 2, and moreover, may be referred to as a transmission apparatus or a transmitting end.

As described above with reference to FIG. 2, a positioning error occurring due to a characteristic of a pseudo-GNSS apparatus may be reduced by using a UWB apparatus together. That is, the composite signal transmission apparatus may be implemented as one integrated apparatus or module where the UWB apparatus and the pseudo-GNSS apparatus are integrated, and thus, may temporally synchronize a pseudo-GNSS signal and a UWB signal with each other to simultaneously transmit the pseudo-GNSS signal and the UWB signal, thereby additionally acquiring information about a physical range between the composite signal transmission apparatus (or a positioning signal providing apparatus) and a user terminal corresponding to a receiving end. The acquired information about the physical range may be used as auxiliary information for signal tracking in a tracking loop module of a pseudo-GNSS receiver of a composite signal reception apparatus described below and may reduce an indoor positioning error.

The composite signal reception apparatus 200 may be a user terminal and may be implemented in a user terminal.

FIG. 4 is a diagram illustrating another example of an internal block diagram of a composite signal transmission apparatus according to embodiments of the present disclosure.

That is, FIG. 4 illustrates an internal block diagram of a composite signal transmission apparatus 100 using a pseudo-GNSS signal and a UWB signal together.

Referring to FIG. 4, the composite signal transmission apparatus 100 may include a master station 410, a GNSS signal generator 420, and a UWB signal generator 430.

The GNSS signal generator 420 may represent the pseudo-GNSS apparatus described above, and the UWB signal generator 430 may represent the UWB apparatus described above.

The master station 410 may analyze a satellite orbit and a satellite signal status to provide the GNSS signal generator 420 and the UWB signal generator 430 with information for generating a composite signal and may correspond to the controller or the processor described above with reference to FIG. 1.

The GNSS signal generator 420 may generate a virtual GNSS signal, based on reception information about a real GNSS signal, and may transmit or radiate the generated GNSS signal. Likewise, the UWB signal generator 430 may generate a UWB signal and may transmit the generated UWB signal. In this case, because the pseudo-GNSS signal and the UWB signal are controlled by the same master station, the pseudo-GNSS signal and the UWB signal may be temporally synchronized with each other.

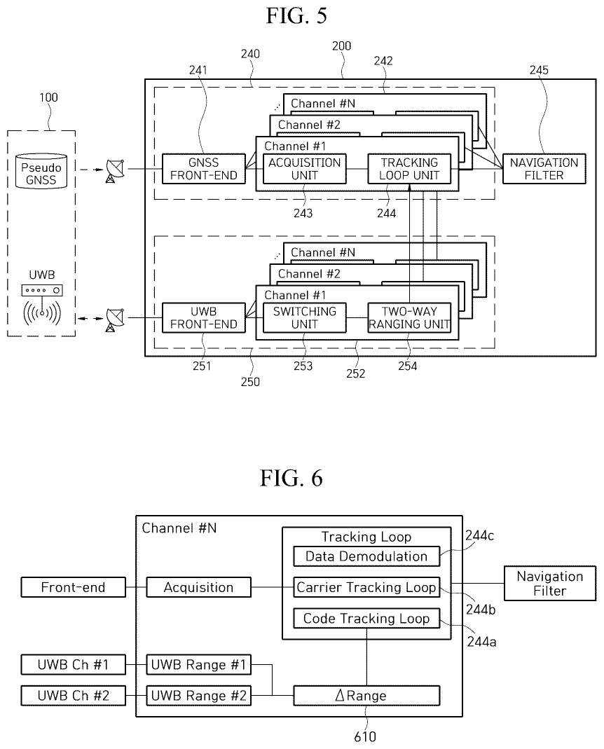

FIG. 5 is a diagram illustrating an example of an internal block diagram of a composite signal reception apparatus 200 according to embodiments of the present disclosure.

Referring to FIG. 5, the composite signal reception apparatus 200 may be implemented as a type where a UWB reception apparatus (or a UWB reception module) is added to a GNSS reception apparatus (or a GNSS reception module) and may be referred to as a reception apparatus, a receiving end, a user terminal, or user equipment.

The composite signal reception apparatus 200 may include a GNSS reception apparatus 240 and a UWB reception apparatus 250.

The composite signal reception apparatus 200 may receive, through an antenna, a pseudo-GNSS signal transmitted from the composite signal transmission apparatus, may convert a radio frequency (RF) signal into an intermediate frequency (IF) signal so that the composite signal reception apparatus 200 processes the received signal through a GNSS front-end 241, and may perform an operation such as discretization. Subsequently, a signal processed through the GNSS front-end may be used to calculate a satellite-based pseudo range through an acquisition unit 243 and a tracking loop unit 244 of each channel 242 of the GNSS reception apparatus. Also, like the GNSS reception apparatus 240, the UWB reception apparatus 250 may also receive and preprocess an UWB signal through an antenna and a UWB front-end 251 and may calculate a physical range between a composite transmission apparatus (or a UWB transmission apparatus) and a composite signal reception apparatus (or a UWB reception apparatus) through a switching unit 253 and a two-way ranging unit 254 each included in each channel of the UWB reception apparatus.

The switching unit may denote a module which converts a transmission signal into a reception signal and may be referred to as a T/R switching unit.

Information about the calculated physical range may be input to a tracking loop unit of the GNSS reception apparatus and may be used as correction information for GNSS signal tracking. Based on a GNSS pseudo range acquired through the correction information, a navigation filter 245 may finally calculate a position of the composite signal reception apparatus.

FIG. 6 is a diagram illustrating another example of an internal block diagram of a composite signal reception apparatus according to embodiments of the present disclosure.

In detail, FIG. 6 illustrates an example of an internal structure of a GNSS reception apparatus for correcting a code tracking result of a code tracking loop of a GNSS reception apparatus by using a UWB signal.

As described above with reference to FIG. 3, a portion where an indoor positioning error largely occurs in a GNSS system may be a position or a zone where a UWB signal and a pseudo-GNSS signal are simultaneously received. However, the quality of a pseudo-GNSS signal received by a GNSS reception apparatus may not be good due to a multipath error or a visual limitation in characteristic of an indoor environment. Therefore, even when a GNSS signal is received through an acquisition unit and a tracking loop unit of the GNSS reception apparatus, because the quality of the received GNSS signal is not good, a possibility that an indoor positioning result is not accurate may be very high. At this time, in a case which uses a UWB signal using one to one or one to a plurality of hand-shaking method in an indoor environment, a range between a transmitting end and a receiving end may be relatively accurately acquired. However, in a case which does not consider a time, a position of a user terminal which is a receiving end may be calculated through trilateration when there are at least three physical ranges, and much cost may be needed for securing a plurality of infrastructures fundamentally. Therefore, the present disclosure may not provide a direct range measurement value but may use the UWB apparatus through the enhancement of accuracy of a signal tracking loop of the GNSS reception apparatus, and thus, cost may be more reduced than the direct use of a UWB range measurement value. That is, as illustrated in FIG. 6, the composite signal reception apparatus may receive, through each UWB channel and UWB range, a signal transmitted from each of two UWB apparatuses to calculate a difference 610 between two physical ranges and may input the difference 610 to a GNSS tracking loop unit to apply a variation of the difference 610 to a discriminator of a GNSS signal tracking loop unit, and thus, it may be possible to complement a pseudo range of a GNSS signal based on the movement of a user terminal.

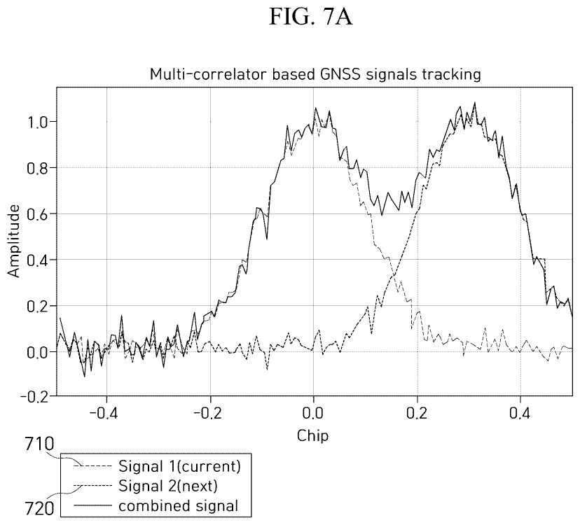

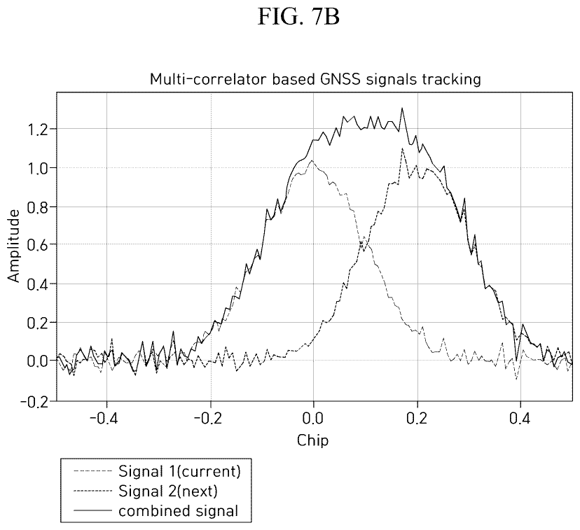

FIGS. 7A and 7B are diagrams illustrating an example of a real signal acquisition result based on a combination of two pseudo-GNSS signals and a multi tracking result of two pseudo-GNSS signals obtained through a composite signal reception apparatus according to embodiments of the present disclosure.

That is, FIGS. 7A and 7B illustrate examples of a multi tracking result of two pseudo-GNSS signals separated through a structure of the composite signal reception apparatus of FIG. 5 and an acquisition result of a real signal where two pseudo-GNSS signals are combined. FIG. 7A illustrates an example of a result of acquiring and tracking a signal through the structure of the composite signal reception apparatus illustrated in FIG. 5. In FIG. 2, when a user terminal or a composite signal reception apparatus is at a position No. 1, a tracking result of a signal transmitted from a pseudo-GNSS apparatus (a first pseudo-GNSS apparatus) provided in a vertical upward direction may represent blue at position No. 1, and a tracking result of a signal transmitted from a second pseudo-GNSS apparatus (a second pseudo-GNSS apparatus) apart from the first pseudo-GNSS apparatus may represent green. Generally, in a case where each pseudo-GNSS apparatus radiates a pseudo-GNSS signal with the same signal strength, the strength of a signal tracking result corresponding to green should be weaker, but the signal reception strengths of green and blue may be illustrated to be equal to each other, for content check. In FIG. 7A, unlike a general GNSS reception apparatus, the composite signal reception apparatus according to embodiments of the present disclosure may simultaneously receive two GNSS signals by using a tracking loop of a multi-signal and may check that the GNSS signals are tracked. In FIG. 7B, when a green signal is approximate and similar to a blue signal, it may be seen that tracking of the green signal to be normally tracked is not performed well.

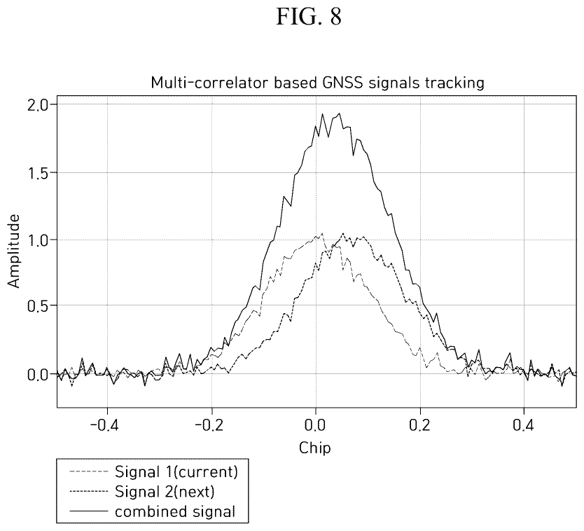

FIG. 8 is a diagram illustrating an example of a result of acquiring a real signal in a composite signal reception apparatus according to embodiments of the present disclosure.

That is, FIG. 8 illustrates an example of a situation where a second signal (a signal transmitted from a second pseudo-GNSS apparatus) among the two pseudo-GNSS signals of FIGS. 7A and 7B approaches a first signal (a signal transmitted from a first pseudo-GNSS apparatus), and due to this, it is difficult to clearly detect a peak.

That is, FIG. 8 illustrates that a situation in FIG. 7B is suitable for a real transmission/reception environment. When it is assumed that a height of a general indoor ceiling is 3 cm, and each composite signal transmission apparatus (pseudo-GNSS +UWB apparatus) is installed with an interval of 20 m, a pseudo-range difference of a pseudo-GNSS signal capable of being acquired from the first pseudo-GNSS apparatus and the second pseudo-GNSS apparatus may be about 0.069 chip(1 chip=about 293 m). FIG. 8 illustrates an arbitrary signal received by a tracking loop of a composite signal reception apparatus when a pseudo-range difference is about 0.069 chip. 0.069 chip which is the pseudo-range difference may be a very small value which is difficult to check through a discriminator of a tracking loop of a general reception apparatus, and in an indoor environment where there are many multipath errors, because various noises are added to a signal, it may be more difficult to check. In an environment where many errors may occur, when a physical range calculated from a UWB signal so as to enhance the signal tracking performance of a GNSS tracking loop is provided as correction information about a tracking loop unit of a pseudo-GNSS reception apparatus, a change in chip corresponding to the pseudo-range difference occurring due to the movement of position of a user terminal may be corrected, and thus, indoor positioning performance may be enhanced.

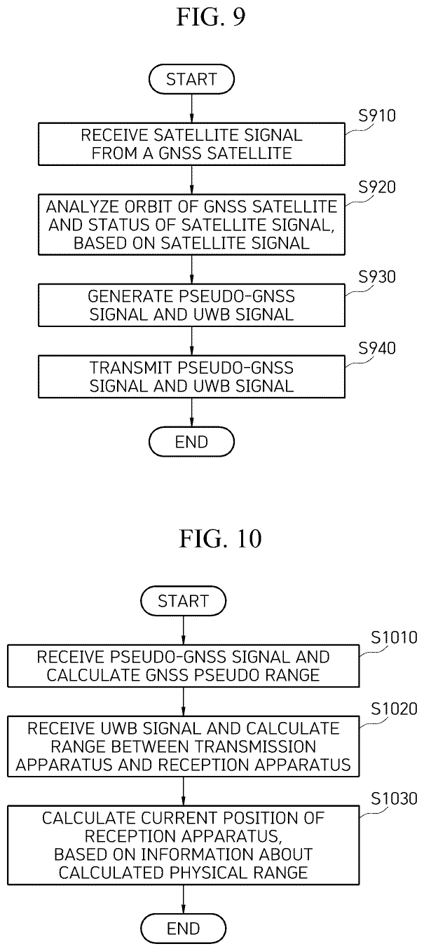

FIG. 9 is a flowchart illustrating an example of a composite signal transmission method for performing indoor positioning in a GNSS system according to embodiments of the present disclosure.

First, a composite signal transmission apparatus may receive a satellite signal through an antenna from a GNSS satellite in step S910.

Moreover, in step S920, the composite signal transmission apparatus may analyze an orbit of a GNSS satellite and a status of the satellite signal, based on the received satellite signal.

Moreover, the composite signal transmission apparatus may generate a pseudo-GNSS signal by using the received satellite signal and may transmit the generated pseudo-GNSS signal.

Moreover, the composite signal transmission apparatus may generate a UWB signal and may transmit the generated UWB signal.

That is, in steps S930 and S940, the composite signal transmission apparatus may generate and transmit the pseudo-GNSS signal and the UWB signal.

The pseudo-GNSS signal and the UWB signal may be temporally synchronized with each other.

Moreover, the composite signal transmission apparatus may analyze an orbit of the GNSS signal and a status of the satellite signal to generate information associated with generating of the pseudo-GNSS signal and the UWB signal.

FIG. 10 is a flowchart illustrating an example of a composite signal reception method for performing indoor positioning in a GNSS system according to embodiments of the present disclosure.

First, in step S1010, a composite signal reception apparatus may receive, through an antenna, a pseudo-GNSS signal transmitted from the composite signal transmission apparatus and may calculate a GNSS satellite-based GNSS pseudo range through signal acquisition and a tracking loop for each channel.

Moreover, in step S1020, the composite signal reception apparatus may receive, through the antenna, a UWB signal transmitted from the composite signal transmission apparatus and may calculate a range between the composite signal transmission apparatus and the composite signal reception apparatus through transmission/reception switching and two-way ranging for each channel.

Moreover, in step S1030, the composite signal reception apparatus may provide range information about the calculated range to the tracking loop to calculate a current position.

Moreover, the composite signal reception apparatus may generate correction information for tracking the pseudo-GNSS signal through the range information, may calculate the GNSS satellite-based GNSS pseudo range by using the generated correction information, and may calculate the current position, based on the calculated GNSS pseudo range.

The embodiments described above may be that the elements and features of the present disclosure are combined in a certain form. Unless separately and explicitly described, each element or feature should be considered to be selective. Each element or feature may be implemented in a form which is not combined with another element or feature. Also, the embodiment of the present disclosure may be configured by combining some elements and/or features with each other. The order of operations described in the embodiments of the present disclosure may be changed. Some elements or features of a certain embodiment may be included in another embodiment, or may be replaced with an element or a feature corresponding to another embodiment. In Claim, it is obvious that an embodiment may be configured by combining claims having no explicit citation relationship, or may be included as a new claim by correction after patent application.

The embodiments according to the present disclosure may be implemented by various means (for example, hardware, firmware, software, or a combination thereof). In implementation based on hardware, an embodiment of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, and microprocessors.

In implementation based on firmware or software, the embodiments of the present disclosure may be implemented in a form such as a module, a process, or a function, which performs functions or operations described above. A software code may be stored in a memory and may be driven by a processor. The memory may be disposed in or outside the processor and may transfer or receive data to or from the processor, based on various means known to those of ordinary skill in the art.

The present disclosure may simplify the installation of a plurality of infrastructures needed for using, as a measurement value, a physical range calculated from a conventional UWB signal through a composite signal transmission/reception processing system for performing precise positioning in an indoor zone by using a (pseudo) GNSS signal and a UWB signal, and moreover, may effectively enhance positioning performance through the improvement of software (SW) in a receiving end or a user terminal.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A composite signal transmission apparatus for performing indoor positioning in a global navigation satellite system (GNSS) system, the composite signal transmission apparatus comprising:
a controller configured to receive a satellite signal through an antenna from a GNSS satellite and analyze an orbit of the GNSS satellite and a status of the satellite signal, based on the received satellite signal;
a GNSS transmitter configured to generate a pseudo-GNSS signal by using the received satellite signal and transmit the generated pseudo-GNSS signal; and
an ultra-wideband (UWB) transmitter configured to generate a UWB signal and transmit the generated UWB signal.

2. The composite signal transmission apparatus of claim 1, wherein the controller analyzes the orbit of the GNSS satellite and the status of the satellite signal to generate information associated with generating of the pseudo-GNSS signal and the UWB signal and provides the information to each of the GNSS transmitter and the UWB transmitter.

3. The composite signal transmission apparatus of claim 2, wherein the controller is functionally connected to the GNSS transmitter and the UWB transmitter, and the GNSS signal and the UWB signal are temporally synchronized with each other.

4. The composite signal transmission apparatus of claim 1, wherein the GNSS transmitter and the UWB transmitter are implemented as one module.

5. A composite signal reception apparatus for performing indoor positioning in a global navigation satellite system (GNSS) system, the composite signal reception apparatus comprising:
a GNSS receiver configured to receive, through an antenna, a pseudo-GNSS signal transmitted from a composite signal transmission apparatus and calculate a GNSS satellite-based GNSS pseudo range through signal acquisition and a tracking loop for each channel;
an ultra-wideband (UWB) receiver configured to receive, through the antenna, a UWB signal transmitted from the composite signal transmission apparatus and calculate a range between the composite signal transmission apparatus and the composite signal reception apparatus through transmission/reception switching and two-way ranging for each channel; and
a controller functionally connected to the GNSS receiver and the UWB receiver,
wherein the controller controls the UWB receiver to provide the tracking loop of the GNSS receiver with range information about the range calculated by the UWB receiver.

6. The composite signal reception apparatus of claim 5, wherein the GNSS receiver generates correction information for tracking the pseudo-GNSS signal, based on the range information.

7. The composite signal reception apparatus of claim 6, further comprising a navigation filter configured to calculate a position of the composite signal reception apparatus.

8. The composite signal reception apparatus of claim 6, wherein the GNSS receiver calculates the GNSS satellite-based GNSS pseudo range by using the correction information.

9. The composite signal reception apparatus of claim 8, wherein the navigation filter calculates a position of the composite signal reception apparatus, based on the calculated GNSS pseudo range.

10. A global navigation satellite system (GNSS) system for performing indoor positioning by using a GNSS signal and an ultra-wideband (UWB) signal, the GNSS system comprising:
a composite signal transmission apparatus configured to analyze an orbit of a GNSS satellite and a status of a satellite signal received from the GNSS satellite, based on the received satellite signal, generate and transmit a pseudo-GNSS signal by using the received satellite signal, and generate and transmit a UWB signal; and
a composite signal reception apparatus configured to receive a pseudo-GNSS signal transmitted from the composite signal transmission apparatus to calculate a GNSS satellite-based GNSS pseudo range through signal acquisition and a tracking loop for each channel and receive a UWB signal transmitted from the composite signal transmission apparatus to calculate a range to the composite signal transmission apparatus through transmission/reception switching and two-way ranging for each channel.

11. The GNSS system of claim 10, wherein the composite signal transmission apparatus analyzes the orbit of the GNSS satellite and the status of the satellite signal to generate information associated with generating of the pseudo-GNSS signal and the UWB signal.

12. The GNSS system of claim 10, wherein the GNSS signal and the UWB signal are temporally synchronized with each other.

13. The GNSS system of claim 10, wherein the composite signal reception apparatus provides the tracking loop with range information about the calculated range to the composite signal transmission apparatus.

14. The GNSS system of claim 13, wherein the composite signal reception apparatus generates correction information for tracking the pseudo-GNSS signal, based on the range information.

15. The GNSS system of claim 14, wherein the composite signal reception apparatus calculates the GNSS satellite-based GNSS pseudo range by using the correction information.

16. The GNSS system of claim 15, wherein the composite signal reception apparatus calculates a position of the composite signal reception apparatus, based on the calculated GNSS pseudo range.
